(19) United States
(12) Patent Application Publication
(10) Pub. No.: US 2016/0170203 A1
(43) Pub. Date: Jun. 16, 2016

(54) ULTRASONIC LENS CLEANING CONVEYOR

(71) Applicant: GM Global Technology Operations LLC, Detroit, MI (US)

(72) Inventors: NORMAN J. WEIGERT, WHITBY (CA); JUSTIN J. GAMMAGE, COBOURG (CA); PAUL W. ALEXANDER, YPSILANTI, MI (US); ANTHONY L. SMITH, TROY, MI (US); HANIF MUHAMMAD, ANN ARBOR, MI (US)

(21) Appl. No.: 14/568,746

(22) Filed: Dec. 12, 2014

(51) Int. Cl. G02B 27/00; B60S 1/56; B08B 3/04; B08B 7/02

(52) U.S. Cl. CPC G02B 27/0006; B08B 7/028; B60S 1/56; B08B 3/04

(57) ABSTRACT

A number of variations may include a product that may include a camera that may include a lens wherein the lens is exposed to the atmosphere and a lens cover disposed over the lens and a transducer in communication with the lens cover.

### TECHNICAL FIELD

The field to which the disclosure generally relates includes lens cleaning technologies.

### BACKGROUND

Lens cleaning technologies in automotive applications commonly use a fluid possibly in combination with compressed air or a mechanical wiper to first dissolve accumulated contaminants and subsequently remove said dissolved contaminants from the surface of a lens or lens cover.

### SUMMARY OF ILLUSTRATIVE VARIATIONS

A number of variations may include a product that may include a camera that may include a lens wherein the lens may be exposed to the atmosphere, a lens cover disposed over the lens, and a transducer in communication with the lens cover.

A number of variations may also include a method that may include the steps of providing a camera that may include a lens wherein the lens may be exposed to the atmosphere and a lens cover disposed over the lens that may include a first surface, a second surface opposite the first surface, a first side opposite a second side, and a third and a fourth side; applying an energy band via a transducer to the first side of the lens cover at a frequency such that the lens cover vibrates and varying the frequency of the energy band such that the energy band may traverse the lens cover from the first side to the second side such that contaminants are removed from the lens cover.

A number of variations may include a method that may include providing a vehicle that may include a camera that may include a lens wherein the lens may be exposed to the atmosphere and a lens cover disposed over the lens that may include a first surface, a second surface opposite the first surface, a first side opposite a second side, and a third side and a fourth and a means for applying fluid to the lens cover to dissolve contaminants on the lens cover; wetting the first surface of the lens cover with a fluid to dissolve contaminants on the first surface; applying an energy band via a transducer to the first side of the lens cover at a frequency such that the lens cover vibrates; and varying the frequency of the energy band such that the energy band traverses the lens cover from the first side to the second side such that contaminants are removed from the lens cover.

A number of variations may include a method that may include providing a vehicle that may include a camera that may include a lens wherein the lens may be exposed to the atmosphere and a lens cover disposed over the lens that may include a first surface, a second surface opposite the first surface, a first side, a second side, and a means for applying fluid to the lens cover to dissolve contaminants on the lens cover; wetting the first surface of the lens cover with a fluid to dissolve contaminants on the first surface; and applying energy via at least two transducers to the first side and the second side of the lens cover at a frequency such that the lens cover vibrates to remove dissolved contaminants from the first surface.

A number of variations may include a product that may a camera that may include a lens wherein the lens may be exposed to the atmosphere; a lens cover disposed over the lens that may include a first side and a second side; a first transducer and a second transducer disposed on the first and second side respectively; and a first mass and a second mass disposed on the first and second side respectively.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1A depicts one variation of an ultrasonic lens cleaning conveyor;

FIG. 1B depicts one variation of an ultrasonic lens cleaning conveyor with exciting energy applied to resonate near the upper portion of the device;

FIG. 1C depicts one variation of an ultrasonic lens cleaning conveyor with exciting energy applied to resonate near the lower portion of the device;

FIG. 2 depicts one variation of an ultrasonic lens cleaning conveyor mounting location;

FIG. 3 depicts one variation of an ultrasonic lens cleaning conveyor including an actuation transducer;

FIG. 4 depicts one variation ultrasonic lens cleaning conveyor; and

FIG. 5 depicts one variation ultrasonic lens cleaning conveyor.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

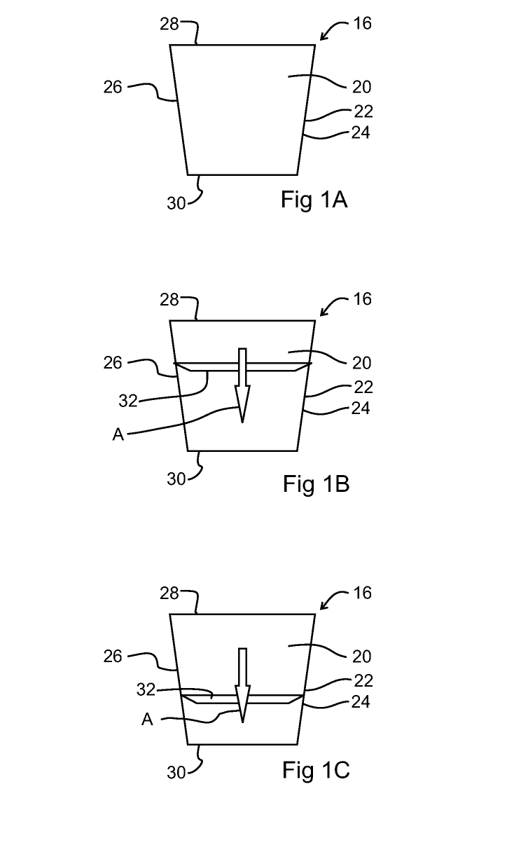

Referring to FIGS. 1A-1C; a lens cover 16 may include a first surface 20, a second surface 22, a first side 24, a second side 26, a wide side 28, and a narrow side 30. The lens cover 16 may be generally trapezoidal in shape. An energy band 32 may be applied to the wide side 28 and the frequency of the energy band 32 may be increased or decreased such that the energy band traverses the length of the lens cover 16 in direction A traveling from the wide side 28 to the narrow side 30.

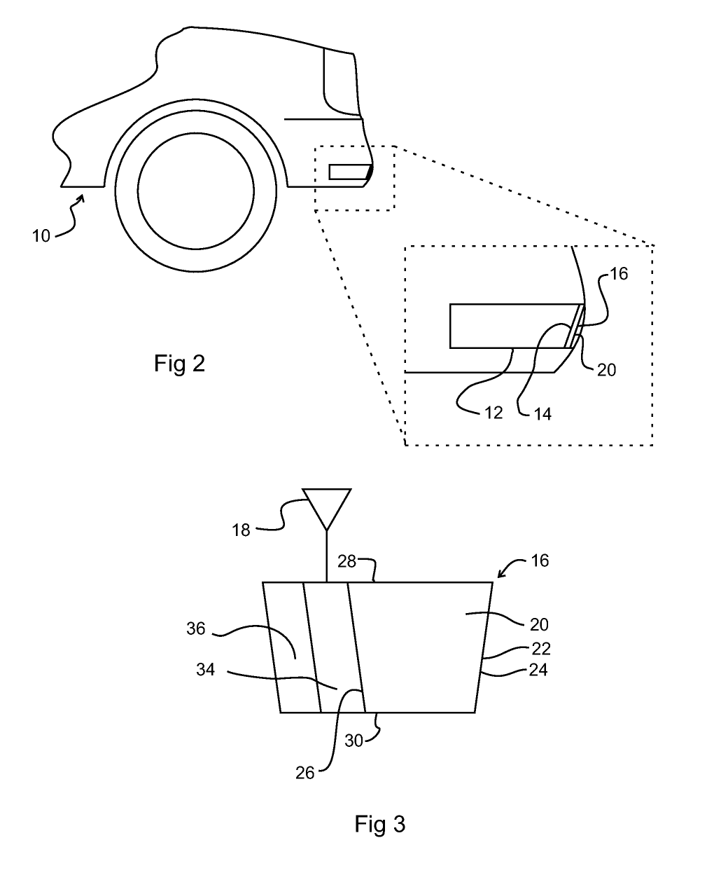

Referring to FIG. 2; a vehicle 10 may include a camera 12 that may include a lens 14. A lens cover 16 may be disposed over the lens 14 of camera 12 and may include a first surface 20. The camera 12 may be disposed within the vehicle 10 such that a driver of the vehicle may be allowed to see behind the vehicle 10 or in front of the vehicle 10.

Referring to FIG. 3; a lens cover 16 may include a first surface 20, a second surface 22, a first side 24, a second side 26, a wide side 28, and a narrow side 30. A transducer 34 may be attached to the first side 24 or second side 26 of the lens cover 16. A mass 36 may be attached to the transducer 34. An transducer 18 may be in communication with the transducer 34, the lens cover 16, or both.

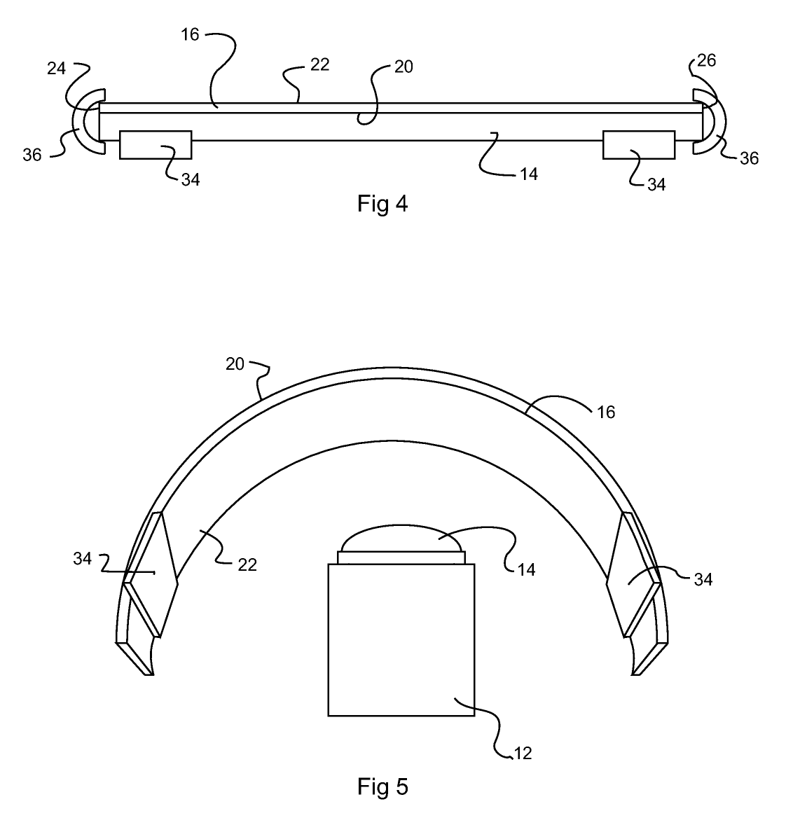

Referring to FIG. 4; first and second transducers 34 may be constructed and arranged to apply an energy band such that the energy band traverses the lens cover 16 such that contaminants are removed from the lens cover 16 and wherein the first and second masses 36 are constructed and arranged to allow generation and propagation of mechanical waves within the lens cover 16.

Referring to FIG. 5; the lens cover 16 may be generally curved in shape and may include first and second transducers 34 that may be constructed and arranged to apply an energy band such that the energy band traverses the lens cover 16 such that contaminants are removed from the lens cover 16. The lens cover 16 may be constructed and arranged to cover the lens 14 of a camera 12.

In practice and in use, the lens cover may be disposed over any camera or camera lens being used in a vehicle. The lens cover may be generally trapezoidal in shape or generally half-cylinder in shape such that it wraps around the lens of a camera. The lens cover may be constructed and arranged to be in communication with an transducer which may apply an energy band to a wide side of the lens cover such that the lens cover resonates or vibrates. Alternatively, an transducer or at least two transducers may be disposed next to or behind the lens cover may be constructed and arranged to receive an electrical signal such that the transducer changes shape and induces vibration within the lens cover. In this way, the transducer may rapidly change shape and induce vibration within the lens cover. When the lens cover vibrates or resonates, contaminants thereon may be removed from either the first surface or the second surface of the lens cover. Additionally, the transducer may be constructed and arranged to increase or decrease the frequency of the energy band such that the energy band traverses the length of the lens cover and in this way may vibrate or resonate the lens cover to remove contaminants thereon. A means for wetting the first surface or second surface, or both, of the lens cover may additionally be provided and may be constructed and arranged to wet the first or second surface of the lens cover prior to application of the energy band. In this way, the first surface or second surface, or both of the lens cover, may be wetted to dissolve contaminants thereon and may be subsequently energized by the transducer wherein the energy band may traverse the length of the lens cover, thereby causing vibration and subsequently removal of contaminants on the lens cover. The transducer may include a piezoelectric material or electromagnetic material or other appropriate material. A mass made of any appropriate material may be disposed on one side or both sides of the transducer opposite the lens covers such that when the transducer energizes the lens cover, the lens cover vibrates rather than allowing the transducer to expend energy into the atmosphere.

According to variation 1, a product may include a camera that may include a lens wherein the lens may be exposed to the atmosphere, a lens cover disposed over the lens, and a transducer in communication with the lens cover.

Variation 2 may include a product as set forth in variation 1, and may further include a means for applying fluid to the lens cover to dissolve contaminants on the lens cover.

Variation 3 may include a product as set forth in variations 1 or 2 wherein the lens cover may include a first surface, a second surface opposite the first surface, a first side opposite a second side, a third side, and a fourth side.

Variation 4 may include a product as set forth in any of variations 1 through 3 wherein the transducer may be constructed and arranged to apply energy to the first side of the lens cover at a frequency such that the lens cover vibrates.

Variation 5 may include a product as set forth in any of variations 1 through 4 wherein the transducer may be constructed and arranged to vary the frequency of the energy such that the energy band traverses the lens cover from the first side to the second side such that dissolved contaminants are removed from the lens cover.

Variation 6 may include a product as set forth in any of variations 1 through 5 and may further include a transducer extending from the first or second side of the lens cover.

Variation 7 may include a product as set forth in variation 6 and may further include a mass extending from the lens cover.

According to variation 8, a method may include providing a camera that may include a lens wherein the lens may be exposed to the atmosphere and a lens cover disposed over the lens that may include a first surface, a second surface opposite the first surface, a first side opposite a second side, and a third and a fourth side; applying an energy band via a transducer to the first side of the lens cover at a frequency such that the lens cover vibrates and varying the frequency of the energy band such that the energy band may traverse the lens cover from the first side to the second side such that contaminants are removed from the lens cover.

Variation 9 may include a method as set forth in variation 8 and may further include a transducer extending from the first or second side of the lens cover.

Variation 10 may include a method as set forth in any of variations 8 through 9 and may further include a mass extending from the lens cover.

Variation 11 may include a method as set forth in any of variations 8 through 10 further comprising a means for applying fluid to the lens cover to dissolve contaminants on the lens cover.

Variation 12 may include a method as set forth in variation 11 and may include wetting the first surface of the lens cover with a fluid via the means for applying fluid to the lens cover to dissolve contaminants on the first surface prior to applying an energy band via a transducer to the first side of the lens cover at a frequency such that the lens cover vibrates.

According to variation 13, a method may include providing a vehicle that may include a camera that may include a lens wherein the lens may be exposed to the atmosphere and a lens cover disposed over the lens that may include a first surface, a second surface opposite the first surface, a first side opposite a second side, and a third side and a fourth and a means for applying fluid to the lens cover to dissolve contaminants on the lens cover; wetting the first surface of the lens cover with a fluid to dissolve contaminants on the first surface; applying an energy band via a transducer to the first side of the lens cover at a frequency such that the lens cover vibrates; and varying the frequency of the energy band such that the energy band traverses the lens cover from the first side to the second side such that contaminants are removed from the lens cover.

According to variation 14, a method may include providing a vehicle that may include a camera that may include a lens wherein the lens may be exposed to the atmosphere and a lens cover disposed over the lens that may include a first surface, a second surface opposite the first surface, a first side, a second side, and a means for applying fluid to the lens cover to dissolve contaminants on the lens cover; wetting the first surface of the lens cover with a fluid to dissolve contaminants on the first surface; and applying energy via at least two transducers to the first side and the second side of the lens cover at a frequency such that the lens cover vibrates to remove dissolved contaminants from the first surface.

Variation 15 may include a method as set forth in variation 14 wherein the lens cover may be generally curved in shape.

Variation 16 may include a method as set forth in any of variations 14 through 15 and may further include varying the frequency of the energy band such that contaminants are removed from the lens cover.

Variation 17 may include a method as set forth in any of variations 14 through 16 and may further include applying energy via the at least two transducers out of phase from one another such that contaminants are removed from the lens cover.

According to variation 18, a product may include a camera that may include a lens wherein the lens may be exposed to the atmosphere; a lens cover disposed over the lens that may include a first side and a second side; a first transducer and a second transducer disposed on the first and second side respectively; and a first mass and a second mass disposed on the first and second side respectively.

Variation 19 may include a product as set forth in variation 18 wherein the lens cover may be generally curved in shape.

Variation 20 may include a product as set forth in any of variations 18 and 19 that may further a means for applying fluid to the lens cover to dissolve contaminants on the lens cover and wherein the first and second transducers are constructed and arranged to apply an energy band such that the energy band traverses the lens cover from the first side to the second side such that dissolved contaminants are removed from the lens cover and wherein the first and second masses are constructed and arranged to allow generation and propagation of mechanical waves within the lens cover.

The above description of variations of the invention is merely demonstrative in nature and, thus, variations thereof are not to be regarded as a departure from the spirit and scope of the inventions disclosed within this document.

What is claimed is:

1. A product comprising:
a camera comprising a lens wherein the lens is exposed to the atmosphere;
a lens cover disposed over the lens; and
a transducer in communication with the lens cover.

2. A product as set forth in claim 1, further comprising a means for applying fluid to the lens cover to dissolve contaminants on the lens cover.

3. A product as set forth in claim 1, wherein the lens cover comprises a first surface, a second surface opposite the first surface, a first side opposite a second side, and a third side and a fourth side.

4. A product as set forth in claim 1, wherein the transducer is constructed and arranged to apply energy to the first side of the lens cover at a frequency such that the lens cover vibrates.

5. A product as set forth in claim 3, wherein the transducer is constructed and arranged to vary the frequency of the energy such that the energy band traverses the lens cover from the first side to the second side such that dissolved contaminants are removed from the lens cover.

6. A product as set forth in claim 1, further comprising a transducer extending from the first or second side of the lens cover.

7. A product as set forth in claim 6, further comprising a mass extending from the lens cover.

8. A method comprising:
providing a camera comprising a lens wherein the lens is exposed to the atmosphere and a lens cover disposed over the lens comprising a first surface, a second surface opposite the first surface, a first side opposite a second side, and a third and a fourth side;
applying an energy band via a transducer to the first side of the lens cover at a frequency such that the lens cover vibrates; and
varying the frequency of the energy band such that the energy band traverses the lens cover from the first side to the second side such that contaminants are removed from the lens cover.

9. A method as set forth in claim 8, further comprising a transducer extending from the first or second side of the lens cover.

10. A method as set forth in claim 8, further comprising a mass extending from the lens cover.

11. A method as set forth in claim 8, wherein the camera further comprises a means for applying fluid to the lens cover to dissolve contaminants on the lens cover.

12. The method as set forth in claim 11 further comprising wetting the first surface of the lens cover with a fluid via the means for applying fluid to the lens cover to dissolve contaminants on the first surface prior to applying an energy band via a transducer to the first side of the lens cover at a frequency such that the lens cover vibrates.

13. A method comprising:
providing a vehicle comprising a camera comprising a lens wherein the lens is exposed to the atmosphere and a lens cover disposed over the lens comprising a first surface, a second surface opposite the first surface, a first side opposite a second side, and a third side and a fourth and a means for applying fluid to the lens cover to dissolve contaminants on the lens cover;
wetting the first surface of the lens cover with a fluid to dissolve contaminants on the first surface;
applying an energy band via a transducer to the first side of the lens cover at a frequency such that the lens cover vibrates; and
varying the frequency of the energy band such that the energy band traverses the lens cover from the first side to the second side such that contaminants are removed from the lens cover.

14. A method comprising
providing a vehicle comprising a camera comprising a lens wherein the lens is exposed to the atmosphere and a lens cover disposed over the lens comprising a first surface, a second surface opposite the first surface, a first side, a second side, and a means for applying fluid to the lens cover to dissolve contaminants on the lens cover;
wetting the first surface of the lens cover with a fluid to dissolve contaminants on the first surface; and
applying energy via at least two transducers to the first side and the second side of the lens cover at a frequency such that the lens cover vibrates to remove dissolved contaminants from the first surface.

15. A method as set forth in claim 14 wherein the lens cover is generally curved in shape.

16. A method as set forth in claim 14 further comprising:
varying the frequency of the energy band such that contaminants are removed from the lens cover.

17. A method as set forth in claim 14 further comprising:
applying energy via the at least two transducers out of phase from one another such that contaminants are removed from the lens cover.

18. A product comprising:
a camera comprising a lens wherein the lens is exposed to the atmosphere;
a lens cover disposed over the lens comprising a first side and a second side;
a first transducer and a second transducer disposed on the first and second side respectively; and
a first mass and a second mass disposed on the first and second side respectively.

19. A product as set forth in claim 17 wherein the lens cover is generally curved in shape.

20. A product as set forth in claim 17 further comprising:
a means for applying fluid to the lens cover to dissolve contaminants on the lens cover and wherein the first and second transducers are constructed and arranged to apply an energy band such that the energy band traverses the lens cover from the first side to the second side such that dissolved contaminants are removed from the lens cover and wherein the first and second masses are constructed and arranged to allow generation and propagation of mechanical waves within the lens cover.
